(19) United States
(12) Patent Application Publication
(10) Pub. No.: US 2021/0140299 A1
(43) Pub. Date: May 13, 2021

(54) METHOD OF DERIVING FLOW PATTERN MAPS FROM DISCRETE DATA POINTS AND ITS APPLICATION IN MULTIPHASE FLOW IN WELLBORES

(71) Applicants: Thomas Dahl, Schwulper (DE); Reza Ettehadi Osgouei, Conroe, TX (US); Roland May, Celle (DE); Roger Aragall, Celle (DE); Charles Anthony Thompson, Kingwood, TX (US)

(72) Inventors: Thomas Dahl, Schwulper (DE); Reza Ettehadi Osgouei, Conroe, TX (US); Roland May, Celle (DE); Roger Aragall, Celle (DE); Charles Anthony Thompson, Kingwood, TX (US)

(73) Assignee: Baker Hughes Oilfield Operations LLC, Houston, TX (US)

(21) Appl. No.: 16/682,249

(22) Filed: Nov. 13, 2019

(51) Int. Cl. E21B 44/00; G06N 20/00; E21B 47/10; E21B 41/00

(52) U.S. Cl. CPC E21B 44/00; G06N 20/00; E21B 2041/0028; E21B 41/00; E21B 47/10

(57) ABSTRACT

A drilling system and method of obtaining a flow pattern in a wellbore. The drilling system includes a device for adjusting an operational parameter of the drilling system, and a processor. The processor trains a machine learning program to identify a flow boundary in parameter space between a first flow pattern region related to a first flow pattern for a multiphase flow and a second flow pattern region related to a second flow pattern for the multiphase flow. The processor identifies the flow boundary for a flow of the multiphase flow in the wellbore and adjusts an operating parameter of the drilling system in the wellbore based on the identified flow boundary to operate the drilling system in one of the first flow pattern region and the second flow pattern region to obtain one of the first flow pattern and the second flow pattern in the wellbore.

### BACKGROUND

In the resource recovery industry, fluid or drilling fluid is circulated through a wellbore in order to clean out cuttings and formation fluid influx from the wellbore. These flows are categorized as multiphase flows such as cuttings transportation and kick circulation. The variety of possible flow configurations for multiphase flow distributions in the annulus distinguishes multiphase flow from single phase flow. The variety of flow patterns differ from each other in the spatial distribution of a flow interface. The interface distribution determines the cross sectional or volumetric fractions of solid, gas and liquid phases in the flow. For example, during a drilling operation, fluid or drilling fluid is pumped downhole through an interior of a drill string to exit at a drill bit at a bottom of the wellbore. The drilling fluid then travels uphole in an annulus between the drill string and a wall of the wellbore in order to transport any cuttings or other particles to the surface. The drilling fluid and cuttings flowing through the wellbore forms various flow patterns that are a function of operational parameters, geometrical variables and physical properties of the phase. The operational parameters include the cuttings and drilling fluid flow rates, for example. Geometrical variables include an annulus clearance and a wellbore inclination angle, for example. The physical properties of the phase include cuttings and drilling fluid densities, viscosities and surface tension, for example.

In some of these flow patterns, cuttings are efficiently transported, while in other flow patterns the transport of cuttings is inefficient. Thus, there is a need for being able to control flow patterns by suitable selection of parameters in order to efficiently clean the wellbore.

### SUMMARY

Disclosed herein is a method of obtaining a flow pattern in a wellbore. A machine learning program is trained to identify a flow boundary between a first flow pattern region and a second flow pattern region in a parameter space, the first flow pattern region related to a first flow pattern for a multiphase flow and the second flow pattern region related to a second flow pattern for a multiphase flow. The flow boundary for a flow of the multiphase flow in the wellbore is identified. An operating parameter of a drilling system in the wellbore is adjusted based on the identified flow boundary to operate the drilling system in one of the first flow pattern region and the second flow pattern region to obtain one of the first flow pattern and the second flow pattern in the wellbore.

Also disclosed herein is a drilling system. The drilling system includes a device for adjusting an operational parameter of the drilling system, and a processor. The processor is configured to train a machine learning algorithm to identify a flow boundary between a first flow pattern region and a second flow pattern region in a parameter space, the first flow pattern region related to a first flow pattern for a multiphase flow and the second flow pattern region related to a second flow pattern for the multiphase flow, identify the flow boundary for the multiphase flow in a wellbore, and control the device to adjust an operating parameter of the drilling system in the wellbore based on the identified flow boundary to operate the drilling system in one of the first flow pattern region and the second flow pattern region to obtain one of the first flow pattern and the second flow pattern in the wellbore.

### BRIEF DESCRIPTION OF THE DRAWINGS

The following descriptions should not be considered limiting in any way. With reference to the accompanying drawings, like elements are numbered alike:

FIG. 1 shows a drilling system 100 in an illustrative embodiment;

FIGS. 2A-2E show various illustrative flow patterns that can occur in multi-phase flows in wellbores, such as constant beds, separated moving beds, continuous moving beds, and heterogeneously or homogeneously dispersed flows;

FIG. 3 illustrates a multi-dimensional parameter space for parametrizing the various flow patterns of FIGS. 2A-2E;

FIG. 4 shows a flowchart illustrating a training process for a machine learning program or neural network;

FIG. 5 shows a flowchart illustrating use of the trained machine learning algorithm of FIG. 4 to determine flow boundaries in a parameter space related to a selected drilling system; and

FIG. 6 shows an illustrative three-dimensional parameter space and flow boundaries that can be determined using the trained machine learning algorithm.

### DETAILED DESCRIPTION

A detailed description of one or more embodiments of the disclosed apparatus and method are presented herein by way of exemplification and not limitation with reference to the Figures.

Referring to FIG. 1, a drilling system 100 is shown in an illustrative embodiment. The drilling system 100 includes a drill string 102 extended from a drilling rig 104 into a wellbore 106 formed in a formation 108. The wellbore 106 of FIG. 1 is shown as including a vertical section 106a and a horizontal section 106b. However, this is not meant to a be a limitation on the invention. The methods disclosed herein can be used with a wellbore having any geometry. The drill string 102 includes a hollow inner bore 114 and forms an annulus 116 between an outer surface of the drill string 102 and a wall 118 of the wellbore 106. The drill string 102 includes a drill bit 110 at a bottom end for drilling the wellbore 106. In other embodiments, any suitable element, tubular, or work string suitable for delivering a fluid or drilling fluid to a selected location in a wellbore can be used in place of the drill string. The drill bit 110 can be rotated by rotation of the drill string 102 from the drilling rig 104 at the surface and/or by rotation of a downhole motor or turbine (not shown). Rotation of the drill bit 110 against the bottom of the wellbore 106 produces cuttings 132. A drilling fluid 112 is used to transport the cuttings 132 to a surface location 130.

In operation, the drilling fluid 112 is pumped from a drilling fluid pit 120 at a surface location 130 downhole through the inner bore 114 of the drilling string 102 via a pump 122 at the surface location 130 and exits the drill string 102 at the drill bit 110. The pump 122 is generally connected with surface pipes (such as hose or standpipe) 124 that transfer the drilling fluid 112 from the drilling fluid pit 120 to a top of the drill string 102. Once the drilling fluid 112 exits the drill string 102 at the drill bit 110, the drilling fluid 112 returns to the surface location 130 via the annulus 116. At the surface location 130, the drilling fluid 112 is returned to the drilling fluid pit 120 via a return line 126. The return line 126 can include additional equipment, such as a flow meter, shale shaker or gas separator, in various embodiments. The effectiveness of the drilling fluid 112 in returning cutting 132 to the surface location 130 is dependent on a flow pattern formed by the drilling fluid and cuttings in the annulus 116, which in turn is dependent on various parameters of the drilling fluid, the cuttings, the wellbore, operational parameters, etc.

The drilling system 100 further includes a control unit 140 that controls various aspects of the drill string 102, drilling fluid pump 122 and other components of the drilling system 100 as well as operational parameters of the drilling system. The control unit 140 includes a processor 142 and a non-transient storage medium such as a solid-state storage device. The storage medium 144 includes therein one or more programs 146 or instructions that when accessed by the processor 142, enable the processor to perform the various calculations and operations disclosed herein. In particular, the processor 142 can receive a trained machine learning program (also referred to herein as a “machine learning algorithm”) or trained neural network, as well as simulation results, from a training and simulation processor (not shown). The trained machine learning program can identify flow pattern regions and flow pattern boundaries in parameter space for multiphase flow. The trained machine-learning algorithm can then be used to identify multiphase flow boundaries in parameter space for the drilling system 100 based on the parameters of the drilling system and adjust one or more operating parameters of the drilling system based on the identified flow boundaries to shift into a flow pattern for drilling fluid and cuttings flowing in the wellbore 106. The flow pattern can be selected for optimizing the transporting of cuttings 132 from the wellbore, for example.

FIGS. 2A-2E show various illustrative flow patterns that can occur in multi-phase drilling fluid and cuttings flowing in an annular space between the drill string and open hole or casing tube. Each of FIGS. 2A-2E shows a horizontal channel defined by a channel top 220 and a channel bottom 222. In various embodiments, the channel is not limited to being horizontal. The fluid is understood to flow in the channel. The channel might include a drill string as well (not shown).

FIG. 2A shows a flow pattern 200A produced by a fluid superficial velocity (first superficial velocity, v₁) of a multiphase flow through the channel. The multi-phase flow can include at least one of a liquid phase and a gas phase. A multi-phase flow including a gas phase can include a gas kick circulating in the wellbore during drilling operations. The flow pattern of 200A is characterized by a constant bed of solid material either motionless or moving at low superficial velocities. The flow pattern 200A includes a bed of material or grain that is stratified into a first layer 204 of material that does not flow or is at a zero superficial velocity and a second layer 206 on top of the first layer 204 that includes material moving through the section at a non-zero superficial velocity. The fluid 202 flowing above the second layer 206 adds motion to the second layer but does not provide enough energy in order to cause the first layer 204 to move.

FIG. 2B shows a flow pattern 200B produced by changing the superficial velocity of the fluid 202 to a second superficial velocity v₂. The second superficial velocity can be greater than the first superficial velocity (i.e., v₂>v₁). In addition or alternatively, the second superficial velocity can differ from the first superficial velocity by having a higher viscosity or by differences in other parameters that affect superficial velocity. The flow pattern 200B is characterized by a material bed that is segmented into separate moving bed regions 208a, 208b, 208c that move along the direction of flow of the fluid. The separate moving bed regions 208a, 208b, 208c are periodically spaced from each other along the length of the channel, with regions of no or substantially no material between them.

FIG. 2C shows a flow pattern 200C produced by changing the superficial velocity of the fluid to a third superficial velocity v₃. The third superficial velocity can be greater than the second superficial velocity (i.e., v₃>v₂). In addition or alternatively, the third superficial velocity can differ from the second superficial velocity by having a higher viscosity or by differences in other parameters that affect superficial velocity. The flow pattern 200C is characterized by a continuous layer 210 of solid grains. As the fluid superficial velocity changes from v₂ to v₃, the regions of no material in flow pattern 200B close to create the continuous layer 210 of flow pattern 200C. An interface 211 between the continuous layer 210 and the fluid 202 displays a periodic spatial variation in the direction of the flow.

FIG. 2D shows a flow pattern 200D produced by changing the superficial velocity of the fluid to a fourth superficial velocity v₄. The fourth superficial velocity can be greater than the third superficial velocity (i.e., v₄>v₃). In addition or alternatively, the fourth superficial velocity can differ from the third superficial velocity by having a higher viscosity or by differences in other parameters that affect superficial velocity. By changing the fluid superficial velocity from v₃ to v₄, the interface 211 of the continuous layer 210 of flow pattern 200C rises to the top of the channel, producing a heterogeneous dispersed flow 212 that extends from channel bottom 222 to channel top 220. The particles of the heterogeneous dispersed flow 212 are heterogeneously dispersed to form a region of relatively high density of particles at the bottom of the heterogeneous dispersed flow 212 and a region of relatively less density at the top of the heterogeneous dispersed flow 212. The relation between density of the heterogeneous dispersed flow 212 and depth is shown in graph 240D.

FIG. 2E shows a flow pattern 200E produced by changing the superficial velocity of the fluid to a fifth superficial velocity v₅. The fifth superficial velocity can be greater than the fourth superficial velocity (i.e., v₃>v₄). In addition or alternatively, the fifth superficial velocity can differ from the fourth superficial velocity by having a higher viscosity or by differences in other parameters that affect superficial velocity. By changing the fluid superficial velocity from v₄ to v₅, the heterogeneous dispersed flow 212 of flow pattern 200D, in which the particles are heterogeneously dispersed, changes to a homogeneous layer 214 of flow pattern 200E, in which the density of particles within the homogeneous layer 214 is relatively constant with depth. The relation between density of the homogeneous layer 214 and depth is shown in graph 240E.

FIGS. 2A-2E show only a small set of possible flow patterns that can occur in a channel Flow patterns can be identified in multiphase flow experimental studies conducted using a circulating fluid and solids using visual observation and/or measurement techniques. Such studies include varying parameters such as wellbore inclination, geometry, operating parameters, etc., and observing the resulting flow patterns. Another way to determine and identify flow patterns is through the application of computational or numerical fluid dynamics models. These results of these studies are discrete data points in an n-dimensional parameter space, such as illustrated in FIG. 3.

FIG. 3 illustrates a parameter space 300 for parametrizing the various flow patterns of FIGS. 2A-2E. The parameter space 300 shows only a two-dimensional space for illustrative purposes. However, it is understood that the flow patterns shown in FIGS. 2A-2E can be dependent upon a plurality of parameters and thus employs a parameter space 300 having dimensions greater than 2. In various embodiments, the flow patterns are a function of parameters such as the circulating fluid rheology and density (in-situ, dependent on pressure and temperature), the solids density, size and shape, the inclination of the wellbore, the annular flow area geometry defined from hole size, tubular size and eccentricity, and operational parameter such as flow rate, rate of penetration and string rotations-per-minute, etc.

Various flow pattern regions R1, R2, R3, R4, Rn are shown in the parameter space 300. For example, the parameter values in flow pattern region R1 can produce a first flow pattern (e.g., the flow pattern of FIG. 2A), the parameter values in flow pattern region R2 can produce a second flow pattern (e.g., the flow pattern of FIG. 2B), etc. Also shown in the parameter space are a plurality of data points 302 obtained via experiment or simulation. Each pattern region is bounded by one or more flow boundaries B1, B2, B3, B4 which define transitions between flow pattern regions. Some flow boundaries can be sharply defined in parameter space, as indicated by sharp flow boundary line 304. Alternatively, a flow boundary can be poorly defined and include a gradual transition region that extends over a range of parameter space, as indicated by the broad flow boundary line 306.

Determining the occurrence of gradual transitions between flow pattern areas at a processor is a problem solvable through pattern recognition techniques or other suitable techniques. Deep learning and neural net pattern recognition techniques can therefore be applied to a data set of flow patterns to identify flow boundaries in parameter space for the flow patterns.

The method disclosed herein includes a method for determining or identifying flow boundaries B1, B2, B3, B4 between various flow pattern regions of a parameter space that parametrizes for fluid flowing in a wellbore. The method includes training a machine learning program such as a neural network to identify flow patterns and their flow pattern regions (e.g., flow pattern regions R1, R2, R3, R4, . . . , Rn) in the n-dimensional parameter space as well as flow boundaries (e.g., flow boundaries B1, B2, B3, B4). The method then evaluates the performance of the machine learning program and then tests the machine learning program. The process can be iterated several times in order to increase the accuracy of the machine learning program. Once the machine learning program is able to identify a plurality of data points with their respective flow pattern regions in parameter space, the machine learning program can determine the locations of flow boundaries in parameter space. The training, evaluating and testing of the machine learning program can be performed in a test setting or laboratory setting. Once the machine learning program is able to identify the flow boundaries in parameter space, the machine learning program can be used in real-time during drilling of the wellbore in order to provide suitable flow patterns within the drilling system.

The training process is performed using data sets obtained from either experimental studies or via numerical simulation. The sparse data points of these data sets can be based on various parameters, e.g. inclination angle, normalized characteristic parameter such as the axial mixture Reynolds number and tangential Reynolds number. These data sets are randomly divided into a training set, a validation set, and a testing set. Then the algorithm architecture is defined, and the algorithm is trained using the training set of data. After training the algorithm, the performance of the trained algorithm is measured using various visualization methods, such as cross-entropy and percent misclassification error. Cross-entropy loss measures the performance of a classification model whose output is a probability value between 0 and 1. Cross-entropy loss increases as the predicted probability diverges from the actual model. A confusion matrix is a table that is often used to describe the performance of a classification model (or “classifier”) on a set of test data for which the true values are known.

Once the machine learning algorithm has been evaluated using test data, the performance of the machine learning algorithm can then be evaluated using a test set of data. The machine learning algorithm can be retrained several times to increase the accuracy with which it is able to identify a flow pattern, its respective flow pattern region in parameter space and its flow boundaries in parameter space. The result of this training procedure is a computer code that can identify the flow pattern of the flow of multi-phase fluids (e.g., drilling fluid and drilled cutting) during drilling operations in the wellbore at different locations and within an acceptable accuracy.

FIG. 4 shows a flowchart 400 illustrating a training process for a machine-learning program that can be, but is not limited to, a neural network. The training process results in a trained machine-learning algorithm capable of determining flow boundaries in parameter space of a drilling system, thereby allowing suitable operation of the drilling system.

In box 402, a training set of data is input into a machine learning algorithm to train the machine learning algorithm. The training set of data can be data from another drilling system, from experiments or data from a simulation. As noted above, the entire data set is randomly divided into the training set, an evaluation set and a test set. In box 402, the machine learning algorithm can be trained to determine or identify flow pattern regions and flow boundaries in a parameter space of the training set of data. In box 404, the trained machine learning algorithm is evaluated using the evaluation set of data. In various embodiments, evaluations can include the visualization methods disclosed above, such as cross-entropy, confusion matrix, etc. The predicted flow boundaries for the training set of data can be compared to an actual flow boundary for the training set of data. In box 406, the results of the evaluation are compared to a threshold. If the results are not within the threshold, the method returns to box 402 for further training. If, at box 406, the results of the evaluation are within the threshold, the method proceeds to box 408 for testing.

In box 408, the trained network is tested using the test data. In box 410, the results of the test is compared to a test threshold. If the results of the test are not within the threshold, the method returns to box 402 for further training. If, at box 410, the results of the test are within the threshold, the method proceeds to box 412. In box 412, the trained machine learning algorithm is used on a selected drilling system, as discussed in further detail with respect to FIG. 5.

FIG. 5 shows a flowchart 500 illustrating use of the trained machine learning algorithm of FIG. 4 to determine flow boundaries in a parameter space related to a selected drilling system, thereby allowing suitable or optimal operation of the drilling system.

In box 502, data from the selected drilling system are input into the trained machine learning algorithm. In box 504, the trained machine learning algorithm predicts flow pattern regions and flow boundaries in parameter space for the input data from the selected drilling system. In box 506, a desired flow pattern is selected. In box 508, the drilling system is operated based on flow pattern related operating data and/or fluid data. In various embodiments, an operating parameter of the drilling system can be adjusted to a value that operates the drilling system within a flow pattern region identified by the trained machine learning algorithm in box 410. In various embodiments, the flow pattern region can be selected for optimal conveyance of the cuttings 132 (FIG. 1) from the annulus of the wellbore.

FIG. 6 shows an illustrative three-dimensional parameter space 600 and flow boundaries that can be determined using the trained machine learning algorithm. For the illustrative parameter space 600, the parameters are the liquid phase superficial Reynolds number, the gas phase superficial Reynolds number and the wellbore inclination angle. Data points 602, 604, 606 through the space identify flow pattern regions of different flow patterns. Classifying the data points 602, 604, 606 according to these flow patterns enables the identification of flow boundaries, such as flow boundaries 610, 612, 614, 616. By accumulating more and additional data points 602, 604, 606, the resolution of flow pattern regions as well as of the flow boundaries 610, 612, 614, 616 can be increased or sharpened. In various embodiments, the sharpness or broadness of a flow boundary can be determined by acquiring a suitable number of data points in parameter space 600.

While discussed herein as determining flow patterns suitable for removal of cuttings from the wellbore, the methods herein can also be used in other applications such as, for example, gas kick circulation and detection, cementing processes, gravel packing, etc.

Set forth below are some embodiments of the foregoing disclosure:

Embodiment 1: A method of obtaining a flow pattern in a wellbore, training a machine learning program to identify a flow boundary between a first flow pattern region and a second flow pattern region in a parameter space, the first flow pattern region related to a first flow pattern for a multiphase flow and the second flow pattern region related to a second flow pattern for a multiphase flow; identifying the flow boundary for a flow of the multiphase flow in the wellbore; and adjusting an operating parameter of a drilling system in the wellbore based on the identified flow boundary to operate the drilling system in one of the first flow pattern region and the second flow pattern region to obtain one of the first flow pattern and the second flow pattern in the wellbore.

Embodiment 2: The method of any prior embodiment, wherein training the machine learning program further comprises using a training set of data to generate a source code that identifies a flow pattern and associates the identified flow pattern with a value of the parameter.

Embodiment 3: The method of any prior embodiment, wherein the training set of data includes a plurality of flow patterns and the machine learning program is trained to identify each of the plurality of flow patterns with a corresponding point in the parameter space.

Embodiment 4: The method of any prior embodiment, wherein the parameter space includes a first point in the first flow pattern region and a second point in the second flow pattern region, further comprising training the machine learning program to determine the flow boundary between the first flow pattern region and the second flow pattern region from the first point and the second point.

Embodiment 5: The method of any prior embodiment, further comprising training the machine learning program to recognize the flow boundary between the first flow pattern region and the second flow pattern region from the first flow pattern associated with a first point in parameter space and the second flow pattern associated with a second point.

Embodiment 6: The method of any prior embodiment, further comprising determining a sharpness of the flow boundary from the first point and the second point.

Embodiment 7: The method of any prior embodiment, wherein the multiphase flow is at least one of: (i) drilling fluid and cuttings; (ii) drilling fluid and gas kick; and (iii) drilling fluid and cement.

Embodiment 8: The method of any prior embodiment, further comprising evaluating the machine learning program using at least one of a cross-entropy method and a percent misclassification error method.

Embodiment 9: A drilling system of a device for adjusting an operational parameter of the drilling system; and a processor configured to train a machine learning algorithm to identify a flow boundary between a first flow pattern region and a second flow pattern region in a parameter space, the first flow pattern region related to a first flow pattern for a multiphase flow and the second flow pattern region related to a second flow pattern for the multiphase flow; identify the flow boundary for the multiphase flow in a wellbore; and control the device to adjust an operating parameter of the drilling system in the wellbore based on the identified flow boundary to operate the drilling system in one of the first flow pattern region and the second flow pattern region to obtain one of the first flow pattern and the second flow pattern in the wellbore,'

Embodiment 10: The drilling system of any prior embodiment, wherein the processor is further configured to train the machine learning algorithm using a training set of data to generate a source code that identifies a flow pattern and associate the identified flow pattern with a value of the parameter.

Embodiment 11: The drilling system of any prior embodiment, wherein the training set of data includes a plurality of flow patterns and the processor is further configured to train the machine learning algorithm to identify each of the plurality of flow patterns with a corresponding point in the parameter space.

Embodiment 12: The drilling system of any prior embodiment, wherein the parameter space includes a first point in the first flow pattern region and a second point in the second flow pattern region and the processor is further configured train the machine learning program to determine the flow boundary between the first flow pattern region and the second flow pattern region from the first point and the second point.

Embodiment 13: The drilling system of any prior embodiment, wherein the processor is further configured to train the machine learning algorithm to recognize the flow boundary between the first flow pattern region and the second flow pattern region from the first flow pattern associated with a first point in parameter space and the second flow pattern associated with a second point.

Embodiment 14: The drilling system of any prior embodiment, wherein the processor is further configured to determine a sharpness of the flow boundary from the first point and the second point.

Embodiment 15: The drilling system of any prior embodiment, wherein the processor is further configured evaluate the machine learning algorithm using at least one of a cross-entropy method and a percent misclassification error method.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

The teachings of the present disclosure may be used in a variety of well operations. These operations may involve using one or more treatment agents to treat a formation, the fluids resident in a formation, a wellbore, and/or equipment in the wellbore, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling fluids, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A method of obtaining a flow pattern in a wellbore, comprising:
training a machine learning program to identify a flow boundary between a first flow pattern region and a second flow pattern region in a parameter space, the first flow pattern region related to a first flow pattern for a multiphase flow and the second flow pattern region related to a second flow pattern for a multiphase flow;
identifying the flow boundary for a flow of the multiphase flow in the wellbore; and
adjusting an operating parameter of a drilling system in the wellbore based on the identified flow boundary to operate the drilling system in one of the first flow pattern region and the second flow pattern region to obtain one of the first flow pattern and the second flow pattern in the wellbore.

2. The method of claim 1, wherein training the machine learning program further comprises using a training set of data to generate a source code that identifies a flow pattern and associates the identified flow pattern with a value of the parameter.

3. The method of claim 2, wherein the training set of data includes a plurality of flow patterns and the machine learning program is trained to identify each of the plurality of flow patterns with a corresponding point in the parameter space.

4. The method of claim 3, wherein the parameter space includes a first point in the first flow pattern region and a second point in the second flow pattern region, further comprising training the machine learning program to determine the flow boundary between the first flow pattern region and the second flow pattern region from the first point and the second point.

5. The method of claim 3, further comprising training the machine learning program to recognize the flow boundary between the first flow pattern region and the second flow pattern region from the first flow pattern associated with a first point in parameter space and the second flow pattern associated with a second point.

6. The method of claim 5, further comprising determining a sharpness of the flow boundary from the first point and the second point.

7. The method of claim 1, wherein the multiphase flow is at least one of: (i) drilling fluid and cuttings; (ii) drilling fluid and gas kick; and (iii) drilling fluid and cement.

8. The method of claim 1, further comprising evaluating the machine learning program using at least one of a cross-entropy method and a percent misclassification error method.

9. A drilling system, comprising:
a device for adjusting an operational parameter of the drilling system; and
a processor configured to:
train a machine learning algorithm to identify a flow boundary between a first flow pattern region and a second flow pattern region in a parameter space, the first flow pattern region related to a first flow pattern for a multiphase flow and the second flow pattern region related to a second flow pattern for the multiphase flow;
identify the flow boundary for the multiphase flow in a wellbore; and
control the device to adjust an operating parameter of the drilling system in the wellbore based on the identified flow boundary to operate the drilling system in one of the first flow pattern region and the second flow pattern region to obtain one of the first flow pattern and the second flow pattern in the wellbore.

10. The drilling system of claim 9, wherein the processor is further configured to train the machine learning algorithm using a training set of data to generate a source code that identifies a flow pattern and associate the identified flow pattern with a value of the parameter.

11. The drilling system of claim 10, wherein the training set of data includes a plurality of flow patterns and the processor is further configured to train the machine learning algorithm to identify each of the plurality of flow patterns with a corresponding point in the parameter space.

12. The drilling system of claim 11, wherein the parameter space includes a first point in the first flow pattern region and a second point in the second flow pattern region and the processor is further configured train the machine learning program to determine the flow boundary between the first flow pattern region and the second flow pattern region from the first point and the second point.

13. The drilling system of claim 11, wherein the processor is further configured to train the machine learning algorithm to recognize the flow boundary between the first flow pattern region and the second flow pattern region from the first flow pattern associated with a first point in parameter space and the second flow pattern associated with a second point.

14. The drilling system of claim 13, wherein the processor is further configured to determine a sharpness of the flow boundary from the first point and the second point.

15. The drilling system of claim 9, wherein the processor is further configured evaluate the machine learning algorithm using at least one of a cross-entropy method and a percent misclassification error method.
